(19) United States
(12) Patent Application Publication
(10) Pub. No.: US 2023/0082344 A1
(43) Pub. Date: Mar. 16, 2023

(54) Method for evaluating theoretical potential of wind energy

(71) Applicant: FIRST INSTITUTE OF OCEANOGRAPHY, NATURAL RESOURCES MINISTRY, Qingdao, Shandong (CN)

(72) Inventors: Congbo Xiong, Qingdao, Shandong (CN); Nana Yue, Qingdao, Shandong (CN); Shantao Wang, Qingdao, Shandong (CN); Dongliang Wang, Yantai, Shandong (CN); Yanling Liu, Qingdao, Shandong (CN); Wenming Zhang, Lianyungang, Jiangsu (CN); Wanqing Chi, Qingdao, Shandong (CN); Xia Li, Qingdao, Shandong (CN); Yongqiang Zhang, Qingdao, Shandong (CN); Shuhua Bian, Qingdao, Shandong (CN); Zegao Yin, Qingdao, Shandong (CN); Yuning Chi, Manzhouli, Inner Mongolia (CN); Hongkai Zhao, Yichang, Hubei (CN); Jianqiang Liu, Qingdao, Shandong (CN); Wanjun Zhang, Qingdao, Shandong (CN); Linhua Hao, Qingdao, Shandong (CN)

(21) Appl. No.: 17/800,050

(22) PCT Filed: Oct. 14, 2021
(86) PCT No.: PCT/CN2021/123858

§ 371 Date: Aug. 16, 2022

(30) Foreign Application Priority Data
Nov. 19, 2020 (CN) 202011300812.X

(51) Int. Cl. G06F 30/20

(52) U.S. Cl. CPC G06F 30/20; G06Q 50/06

(57) ABSTRACT

A method for evaluating theoretical potential of wind energy includes steps of: (1) selecting a target area for estimation of theoretical reserves of wind energy, and extracting a coordinate range of the target area; (2) presetting a spatial height of the target area d in step (1); (3) obtaining meteorological data of a wind speed and an air density of the target area in step (2); (4) according to the meteorological data obtained in step (3), calculating a theoretical wind reserves per unit area of the target area; (5) calculating an area size of the target area; (6) according to the meteorological data of the wind speed and the air density obtained in step (3), the spatial height of the target area obtained in step (2), and the area size of the target area obtained in step (5), calculating to obtain regional theoretical reserves of wind. Benefits of the present invention are providing a quantitative evaluation method for the estimation of the theoretical reserves of global wind energy, the quantitative indicators of wind power resources for wind energy policy formulation, and the selection of wind farm sites, which are of great significance for the development and utilization of wind resources and the formulation of policies.

### BACKGROUND OF THE PRESENT INVENTION

### Field of Invention

The present invention relates to the technical field of renewable energy evaluation, and more particularly to a method for evaluating theoretical potential of wind energy.

### Description of Related Arts

At present, there is a lot of controversy in the estimation of global wind energy. Some scholars, for instance, Cristina L. Archer in 2013 and Jingxuan Feng in 2020, have analyzed various disclosures with different estimation values, wherein the causes are as follows.

Firstly, the actual content of the estimation is different, that is, the concept of wind energy is different. The wind energy is mainly classified into theoretical potential, technical potential, practical potential and economic potential; or alternatively classified into theoretical potential, geographical potential, technical potential, economic potential and net potential. It can be seen that with the refinement of the concept, it becomes more and more difficult to accurately estimate wind energy reserves. Throughout the estimation of wind energy reserves under different concepts, it is necessary to accurately estimate the theoretical wind energy reserves (wind kinetic energy or Theoretical potential). The calculation method of theoretical wind energy reserves is not further improved at present. Some scholars believe that solar radiation is the main source of wind energy. By estimating that the solar energy absorbed by the atmosphere is 175, 000TW, and it is believed that only part of the solar energy absorbed by the atmosphere is converted into wind energy, and then reserve of wind energy is estimated. It is true that if there is no solar radiation energy, there is almost no wind, but the magnitude of wind energy is not just a simple conversion of solar radiation energy. Different specific heat capacities of land and water areas in the earth’s space, different topography and terrain, and different temperature and pressure will cause different wind forces. If only the sun is considered, it is not suitable to convert radiant energy into wind energy.

Secondly, the commonly applied method for evaluating wind energy is based on the concept of a kinetic energy of wind, that is, wind power capacity,

$$\text{W} = \frac{1}{2} ρ {V}^{3}$$

or wind power density,

$$\text{P =} \frac{1}{2} ρ {V}^{3} A$$

,both of which are actually based on the kinetic energy of wind, wherein the latter formula is the derived formula of the former formula, i.e., by dividing the former formula by the area.The condition that the former formula wind satisfies kinetic energy is that the wind speed must be perpendicular to the area, which results in that the wind energy density can calculate the distribution of wind energy density in space; however, it is very difficult to calculate the regional wind energy reserves by this method.

Therefore, the present invention provides a new method for evaluating theoretical reserves of wind energy, which can provide a method for evaluating the theoretical reserves of wind energy in a limited height space for the target area.

### SUMMARY OF THE PRESENT INVENTION

Technical problems to be solved by the present invention are: to overcome the deficiencies of the conventional arts, and provides a new method for evaluating theoretical reserves of wind energy. Objects of the present invention is to calculate theoretical reserves of wind per unit area of a target area within a specified height according to data of a wind speed and an air density; calculate theoretical reserves of regional wind energy by the formula for calculating the theoretical reserves distribution of wind per unit area; calculate the theoretical reserves of regional wind and perform wind energy resource assessment.

Accordingly, in order to solve the technical problems mentioned above, technical solutions adopted by the present invention are as follows.

A method for evaluating theoretical potential of wind comprises steps of:
(1) selecting a target area for estimation of theoretical reserves of wind, and extracting a coordinate range of the target area;
   wherein the coordinate range of the target area is a sequence of longitude and latitude of boundary inflection points in order; projected plane rectangular coordinates; or a description of a spatial geometric scale with a coordinate point as a reference;
(2) presetting a spatial height of the target area d in step (1);
(3) obtaining meteorological data of a wind speed and an air density of the target area in step (2);
   wherein the meteorological data of the wind speed and the air density of the target area are data of one or more discrete points measured or calculated by numerical simulation methods;
   when meteorological data of the wind speed and air density of multiple discrete points are obtained, dividing the target area into small grids, a step size of a maximum grid is less than or equal to ⅒ of a distance from a nearest data point; the meteorological data of the air density is interpolated to a grid center point;
(4) according to the meteorological data obtained in step (3), calculating a theoretical wind reserves per unit area of the target area;
(5) calculating an area size of the target area;
   wherein the area size of the target area a calculated by utilizing equal-area projection, geometric figure area calculation method, polygon area calculation method, or with aids of AutoCAD, ArcGis, MapGis, and Mapinfor geographic information systems;
(6) according to the meteorological data of the wind speed and the air density obtained in step (3), the spatial height of the target area obtained in step (2), and the area size of the target area obtained in step (5), calculating to obtain regional theoretical reserves of wind.

Preferably, in step (4), the theoretical wind reserves per unit area of the target area is calculated according to following formula:

$${\text{E}}_{D} = \int \left(1 / 2 ρ {V}^{2}\right) d z ;$$

E_{D} is the theoretical wind energy reserves per unit area of the target area, V is a wind speed, ρ is the air density, and dz is a small increment of height in a vertical direction.

Preferably, in the step (6) of according to the calculation formula of regional theoretical reserves of the wind, calculating to obtain regional theoretical reserves of wind, the calculation formula of regional theoretical reserves of the wind is:

$${\text{E}}_{\text{R}} = \int \int \int \left(1 / 2 ρ {V}^{2}\right) d x d y d z ;$$

wherein: E_{R} is the theoretical reserves of regional wind, V is a wind speed that varies with height; ρ is the air density; dz is the small increment of height in the vertical direction, which is determined according to vertical distribution of meteorological data; ∫∫dxdy is the area size of the target area estimated by selecting the theoretical wind reserves, wherein dxdy is a space step size, which depends on locations of the meteorological data on a plane and meteorological complexity of the target area.

### BRIEF DESCRIPTION OF THE DRAWINGS

FIG. 1 is a basic flow chart of a method for evaluating theoretical reserves of wind according to a preferred embodiment of the present invention;

FIG. 2 is a diagram showing the variation process of global wind energy theoretical reserves with time according to the preferred embodiment of the present invention;

FIG. 3 is a distribution diagram of the theoretical reserves of wind energy per unit area in the world according to the preferred embodiment of the present invention.

### DETAILED DESCRIPTION OF THE PREFERRED EMBODIMENT

The technical solutions of the present invention will be further described below with reference to the accompanying drawings.

### Embodiment 1

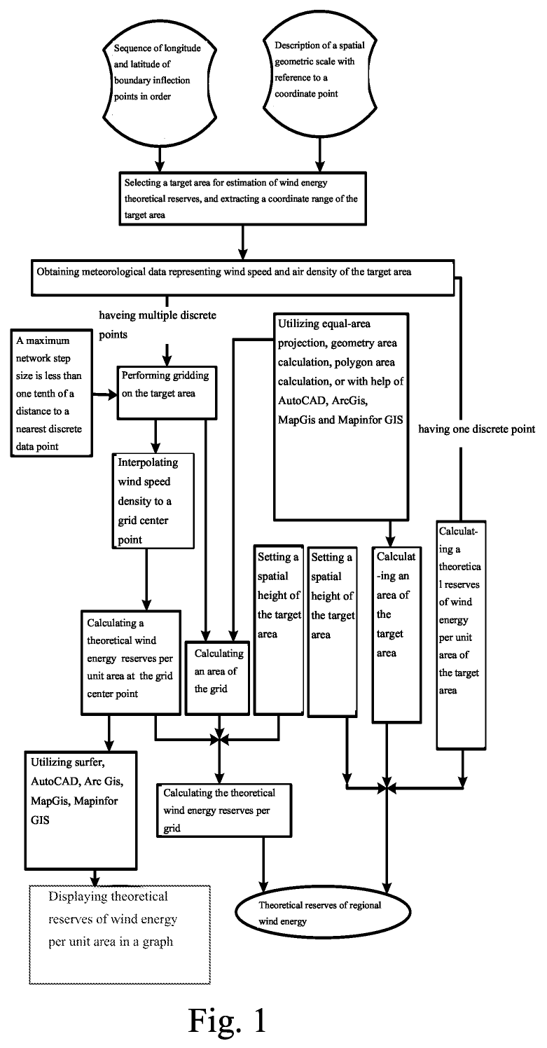

As shown in FIGS. 1, 2, and 3, a method for evaluating the theoretical reserves of wind energy includes the following steps:

1) Select the target area for wind energy theoretical reserve estimation, and extract the coordinate range of the target area;

The coordinate range of the target area is the sequence of the longitude and latitude of the boundary inflection points arranged in sequence (or the projected plane rectangular coordinates).

In this embodiment, the global scope is selected as the target area, and the specific target area coordinate range is the sequence of longitude and latitude of the range coordinate points arranged in order (or the projected plane rectangular coordinates). The specific form of the area range sequence is as follows:

| Longitude sequence | Latitude sequence | Remarks |
|---|---|---|
| -180 | -90 | Boundary inflection point number 1 |
| 180 | -90 | Boundary inflection point number 2 |
| 180 | 90 | Boundary inflection point number 3 |
| -180 | 90 | Boundary inflection point number 4 |
| -180 | 90 | Boundary inflection point number 1 |

2) Specify the spatial height of the target area in step (1);

The spatial height of the target area in this embodiment is within a spatial height range of 100 m above the ground in the global scope.

3) Obtain meteorological data representing the wind speed and air density of the target area space in step (2);

The meteorological data of wind speed and air density in the space of the target area are the data of one or more discrete points measured; or, the data of one or more discrete points calculated by numerical simulation method;

In this embodiment, the calculation result data of the spatial distribution obtained by the numerical simulation method is selected, and the grid calculated by the global atmospheric model ECMWF is 2.5°×2.5° data of wind speed, air temperature, and atmospheric surface pressure as the meteorological data required for the calculation of the target area; the acquired data is 72×144 data.

The acquired data is the meteorological data of wind speed and air density of multiple discrete points. The target area is divided into small grids, and the maximum grid step size is less than or equal to ⅒ of the distance from the nearest data point. The meteorological data of wind speed and air density are interpolated to the center point of the grid;

The data is interpolated to the center point of a small grid of 0.25°×0.25° by the inverse distance interpolation method, and the obtained data is 720×1440 data.

In this embodiment, the air density at the center point of the grid is calculated by using the ideal gas equation of state through the obtained air temperature and atmospheric surface pressure data.

4) Calculate the theoretical reserves of wind energy per unit area of the target area according to the meteorological data obtained in step 3;

The specific formula for calculating the theoretical reserves of wind energy per unit area in the target area is as follows:

$${\text{E}}_{D} = \int \left(1 / 2 ρ {V}^{2}\right) d z ;$$

wherein: E_{D} is the theoretical wind energy reserve per unit area, V is the wind speed, ρ is the air density, and dz is a small increment of height in a vertical direction.

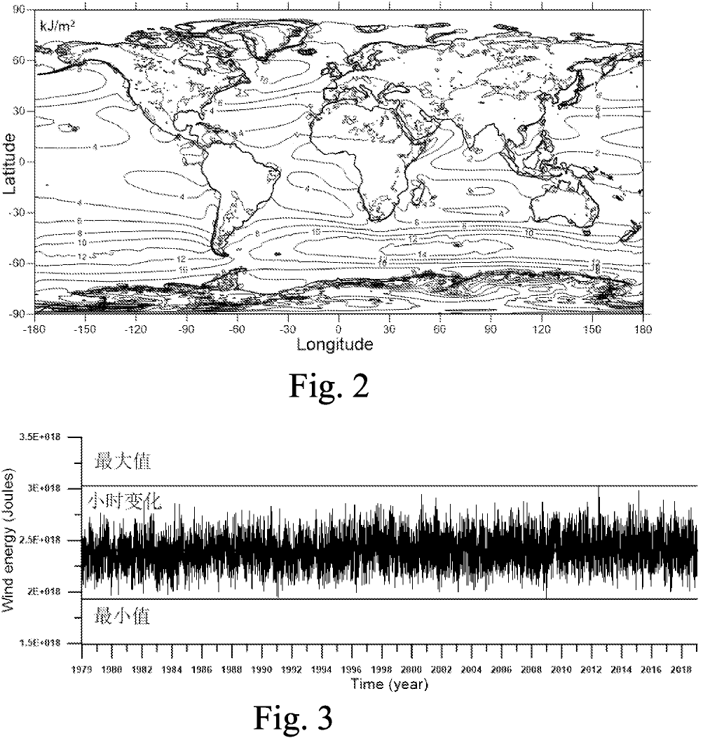

The calculation results can use surfer, AutoCAD, ArcGis, MapGis, Mapinfor and other geographic information system software to make a global distribution map of wind energy theoretical reserves per unit area, see FIG. 2, and evaluate the status of wind energy resources through the value of theoretical wind energy reserves per unit area in FIG. 2 pros and cons.

5) Calculate the area of the target area;

For the area of the target area, use equal-area projection, geometric figure area calculation method, polygon area calculation method, or use AutoCAD, ArcGis, MapGis, Mapinfor geographic information system to calculate the area area;

In order to accurately calculate the theoretical reserves of global wind energy, in this embodiment, the projection of Equal Area is used to calculate the grid areas of the target area. The calculated grid area of 0.25° × 0.25° is from latitude -90° to 0°, the area gradually increases from 422252 m² to 774500608 m². By summing the area of each cell in the world, the surface area of the earth in the target area is 511206687559530 m².

6) According to the meteorological data of wind speed and air density obtained in step 3, the spatial height of the target area specified in step 2, and the area of the target area obtained in step 5, calculate the theoretical reserves of regional wind energy within the spatial range of the target area.

The formula for calculating the theoretical reserves of wind energy in the target area is as follows:

$${\text{E}}_{\text{R}} = ∭ \left(1 / 2 ρ {V}^{2}\right) d x d y d z ;$$

In the formula: E_{R} is the theoretical reserve of regional wind energy, V is the wind speed that changes with height; ρ is the air density; dz is the small increment of height in the vertical direction, which is determined according to the vertical distribution of meteorological data; ∫∫dxdy is the estimated wind energy theoretical reserve The area of the target area, where dxdy is the space step size, which depends on the location of the meteorological data on the plane and the meteorological complexity of the target area.

In this embodiment, the air temperature and air pressure calculated by ECMWF are used to calculate the air density at the center point of the grid using the ideal gas equation of state. The small increment of height in the vertical direction dz is taken as the height of 100 m in this embodiment, and dxdy is the space step long, in this embodiment, the grid of 0.25°×0.25° of ECMWF is selected.

In this example, the hourly wind energy from Jan. 1, 1979 to Dec. 31, 2019 is calculated according to the above formula to calculate the global theoretical wind energy storage space of 100 m above the surface. The fluctuation range of the global theoretical wind energy storage is from 1.9×10¹⁸ joules to 3.0 between ×10¹⁸ joules, the 41 years average is 2.4 × 10¹⁸ joules. The specific time course is shown in FIG. 3.

### Embodiment 2

As shown in FIGS. 1, 2, and 3, a method for evaluating the theoretical reserves of wind energy comprises the following steps:

Select the target area for the estimation of wind energy theoretical reserves, and extract the coordinate range of the target area;

The coordinate range of the target area is a description of the spatial geometric scale with a coordinate point as a reference.

In this embodiment, a certain fan (geographical coordinates is 119.015432°E, 37.220934°N) is selected as an example, and the specific coordinate range of the target area is a circular bottom surface with a radius of 200 m centered on the fan base.

Specify the spatial height of the target area in step 1;

The spatial height of the target area in this embodiment is in a cylindrical space with a height of 200 m.

Obtain meteorological data representing the wind speed and air density of the target area space in step (2);

The meteorological data of the wind speed and air density of the target area space is the data of one or more discrete points measured; or, the data of one or more discrete points calculated by numerical simulation method;

In this embodiment, the average measured vertical layered wind speed data of a station in 2011 is selected, and the specific data format is as follows:

| Height (m) | Wind speed (m/s) | Wind direction (°) |
|---|---|---|
| 10 | 3. 5 | 197 |
| 50 | 3. 8 | 193 |
| 90 | 4. 2 | 186 |
| 170 | 4. 3 | 182 |

The empirical data used for air density is 1.225 kg/m³.

4) Calculate the theoretical reserves of wind energy per unit area of the target area according to the meteorological data obtained in step 3;

The specific formula for calculating the theoretical reserves of wind energy per unit area in the target area is as follows:

$${E}_{D} = \int \left(1 / 2 ρ {V}^{2}\right) d z ;$$

wherein: E_{D} is the theoretical wind energy reserve per unit area, V is the wind speed, ρ is the air density, and dz is the small increment of height in the vertical direction.

In this embodiment, according to the vertical stratification of the obtained wind speed, the stratification is performed according to the intermediate stratification method.

In this embodiment, the theoretical storage of wind energy per unit area of space in the selected area is calculated according to the above formula near a certain fan, and the calculation result is about 2020 joules/square meter.

5) Calculate the area of the target area;

The target area is a regular cylinder, which is a circle with a base area of 200 m in radius, and its area is 125600 m² calculated according to the geometric figure area (circle area) calculation method.

According to the meteorological data of wind speed and air density obtained in step 3, the spatial height of the target area specified in step (2), and the area of the target area obtained in step (5), calculate the theoretical reserves of regional wind energy within the spatial range of the target area.

The formula for calculating the theoretical reserves of wind energy in the target area is as follows:

$${\text{E}}_{\text{R}} = ∭ \left(1 / 2 ρ {V}^{2}\right) d x d y d z ;$$

In the formula: E_{R} is the theoretical reserve of regional wind energy, V is the wind speed that changes with height; ρ is the air density; dz is the small increment of height in the vertical direction, which is determined according to the vertical distribution of meteorological data; ∫∫dxdy is the estimated wind energy theoretical reserve The area of the target area, where dxdy is the space step size, which depends on the location of the meteorological data on the plane and the meteorological complexity of the target area.

The empirical data used for air density in this embodiment is 1.225 kg/m³.

In this embodiment, according to the vertical stratification of the obtained wind speed, the stratification is performed according to the intermediate stratification method. ∫∫dxdy is the area, and the area obtained in step 4 is selected in this embodiment.

In this example, the theoretical wind energy storage in the selected area space is calculated according to the above formula near a certain fan. The theoretical wind energy storage in the circular bottom surface with a radius of 200 m and a cylindrical space with a height of 200 m near the fan is 2.536 × 10⁸ joules.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method for evaluating theoretical potential of wind comprising steps of:
(1) selecting a target area for estimation of theoretical reserves of wind, and extracting a coordinate range of the target area;
wherein the coordinate range of the target area is a sequence of longitude and latitude of boundary inflection points in order; projected plane rectangular coordinates; or a description of a spatial geometric scale with a coordinate point as a reference;
(2) presetting a spatial height of the target area in step (1);
(3) obtaining meteorological data of a wind speed and an air density of the target area in step (2);
wherein the meteorological data of the wind speed and the air density of the target area are data of one or more discrete points measured or calculated by numerical simulation methods;
when meteorological data of the wind speed and air density of multiple discrete points are obtained, dividing the target area into small grids, a step size of a maximum grid is less than or equal to ⅒ of a distance from a nearest data point; the meteorological data of the air density is interpolated to a grid center point;
(4) according to the meteorological data obtained in step (3), calculating a theoretical wind reserves per unit area of the target area;
(5) calculating an area size of the target area;
wherein the area size of the target area a calculated by utilizing equal-area projection, geometric figure area calculation method, polygon area calculation method, or with aids of AutoCAD, ArcGis, MapGis, and Mapinfor geographic information systems;
(6) according to the meteorological data of the wind speed and the air density obtained in step (3), the spatial height of the target area obtained in step (2), and the area size of the target area obtained in step (5), calculating to obtain regional theoretical reserves of wind.

2. The method for evaluating theoretical potential of wind, as recited in claim 1, wherein in step (4), the theoretical wind reserves per unit area of the target area is calculated according to following formula:
$${E}_{D} = \int \left(1 / 2 ρ {V}^{2}\right) d z ;$$
E_{D} is the theoretical wind reserves per unit area of the target area, V is a wind speed, ρ is the air density, and dz is a small increment of height in a vertical direction.

3. The method for evaluating theoretical potential of wind, as recited in claim 3, wherein in the step (6) of according to the calculation formula of regional theoretical reserves of the wind, calculating to obtain regional theoretical reserves of wind, the calculation formula of regional theoretical reserves of the wind is:
$${\text{E}}_{\text{R}} = ∭ \left(1 / 2 ρ {V}^{2}\right) d x d y d z$$
wherein: E_{R} is the theoretical reserves of regional wind, V is a wind speed that varies with height; p is the air density; dz is the small increment of height in the vertical direction, which is determined according to vertical distribution of meteorological data; ∬ dxdy is the area size of the target area estimated by selecting the theoretical wind reserves, wherein dxdy is a space step size, which depends on locations of the meteorological data on a plane and meteorological complexity of the target area.
